(19) United States
(12) Patent Application Publication
(10) Pub. No.: US 2010/0027301 A1
(43) Pub. Date: Feb. 4, 2010

(54) BAND-PASS CURRENT MODE CONTROL SCHEME FOR SWITCHING POWER CONVERTERS WITH HIGHER-ORDER OUTPUT FILTERS

(75) Inventor: MIKKEL CHRISTIAN WENDELBOE HOYERBY, KOBENHAVN SV (DK)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/183,156

(22) Filed: Jul. 31, 2008

(51) Int. Cl. H02M 1/14

(52) U.S. Cl. 363/39

(57) ABSTRACT

A DC-DC converter is described that contains multiple estimators and is self-oscillation. The converter also contains at least a fourth order output filter. The converter contains both feedback and feed-forward paths. The estimators estimate the current through inductors in the filter by sensing the voltage across the inductors.

The forward feed path contains a comparator. The self-oscillation is provided by hysteresis in the comparator or by a phase-shift network connected to the comparator. The estimators comprise extra windings coupled to each inductor or a series combination of a resistor and a capacitor connected in parallel with the inductor.

### TECHNICAL FIELD

The present application relates to power amplifiers. In particular, the application relates to the power amplifiers having output inductors and feedback loops containing estimates of the current through the inductors.

### BACKGROUND

Power amplifiers are used in a variety of applications. In communication systems, for example, power amplifiers provide the desired signal strength for radio frequency (RF) wireless transmissions between a base station and a wireless handset. A power supply provides power to the power amplifier. In some communication power amplifier systems, an Ultra-Fast Tracking Power Supply (UFTPS) is employed to better control the power amplifier in the transmitter to provide the desired instantaneous output power level, thereby better maximizing the efficiency of the power amplifier by limiting the wasted power.

To realize power savings in the system, the UFTPS is to act as a low-dissipation controllable voltage source from DC to the RF bandwidth. It is thus desirable for the UFTPS to have sufficiently low power losses. The UFTPS typically employs a switch-mode power converter to provide such a low power loss. Besides power savings, reducing the response time is also desirable. Accordingly, it is desirable for the output voltage of the UFTPS to respond relatively quickly to changes in the reference voltages—ideally at a rate equivalent to the bandwidth of the transmitted signal (e.g., 25-150 kHz). Further, to avoid interference when intermodulation of the output occurs with the transmitted RF signal, it is desirable for the output ripple voltage of the switch-mode power converters to be relatively small, e.g., 5-50 mVpp. Also, it is desirable for the UFTPS to have a relatively low output impedance (e.g., 10-100 mΩ) from DC to the RF bandwidth.

One example of a commonly-used power supply is a single-phase buck converter (in which a single DC-DC converter is disposed between the input and the load). A buck converter in a UFTPS application may contain one or more output filters coupled with multiple proportional-derivative (PD) control loops to form a proportional-integral-derivative (PID) controller. However, while a buck converter that contains multiple LC filters and control loops is useful in an UFTPS application, the components used in the control loops are subject to practical implementation problems such as increased power consumption, noise sensitivity, and sensitivity to circuit parasitics. It is accordingly desirable to provide a buck converter that reduces these problems.

### BRIEF DESCRIPTION OF THE DRAWINGS

Embodiments will now be described by way of example with reference to the accompanying drawings, in which:

FIG. 1 illustrates a BPCM control buck converter according to one embodiment.

FIG. 2 illustrates a BPCM control buck converter according to another embodiment.

FIG. 3 shows a portion of a BPCM control buck converter according to another embodiment.

FIG. 4 shows a portion of a BPCM control buck converter according to another embodiment.

FIG. 5 illustrates a BPCM control buck converter according to another embodiment.

FIG. 6 illustrates one embodiment of a power amplifier system containing a UFTPS.

### DETAILED DESCRIPTION

A power amplifier system containing a buck converter and method of providing DC-DC conversion is described. The power amplifier system contains multiple estimators and self-oscillating control in a multiple order filtered buck converter. The buck converter contains feedback and feed-forward control paths. The feed-forward path contains a comparator. The self-oscillation is provided either by a phase-shift network disposed before the comparator in the feed-forward signal path or by hysteresis in the comparator. The estimators estimate currents through the inductors and capacitors in the output filter by sensing the voltage across the inductors.

The various individual components are well-known to one of skill in the art and will not be described in detail. Further, other circuitry that is associated with the power amplifier system and is well-known to one of skill in the art will not be described for conciseness.

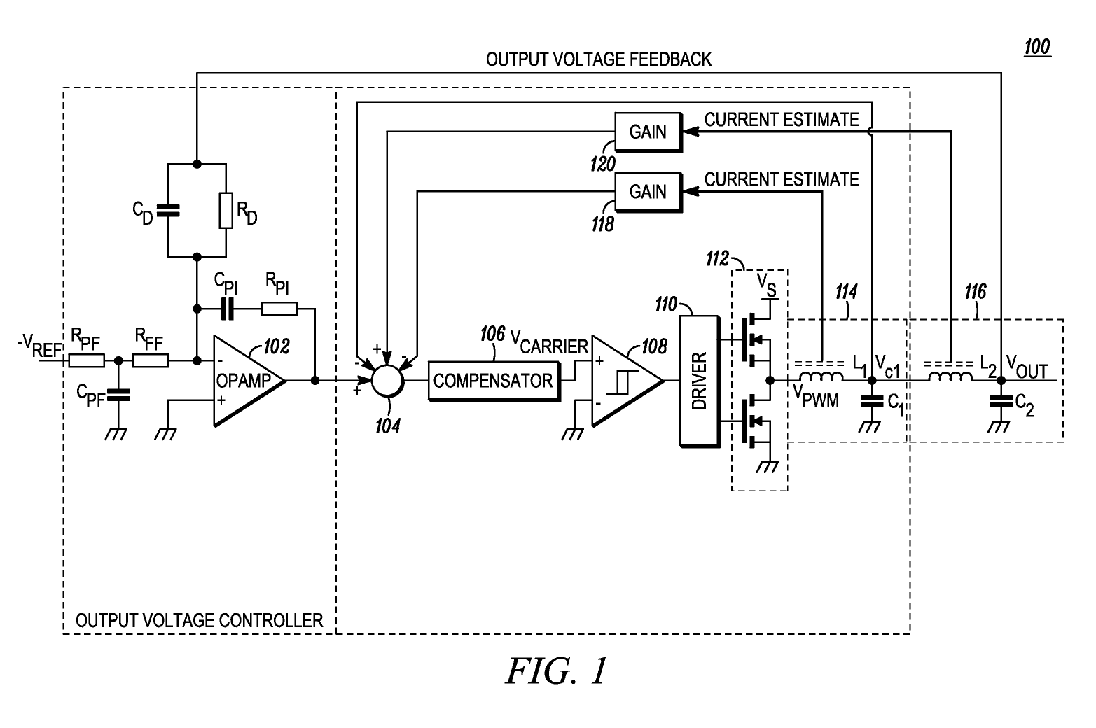

FIG. 1 illustrates one embodiment of a switch-mode power converter. The power converter shown is a Band Pass Current Mode (BPCM) controlled buck converter, with Band-Pass Current Mode Feedback arranged as to achieve the dynamics of a Global Loop Integrating Modulator (GLIM). The BPCM buck converter in general contains a switching power converter with an output filter in which multiple loops provide feedback from the output filters. The BPCM buck converter 100 shown uses an estimate of the inductor current rather than using direct voltage measurements as feedback to control the buck converter 100. The BPCM current feedback signals, along with the feedback of one of the capacitor voltages (V_{cl}) of a capacitor C₁ in the output filter, function together to effectively create feedback control of the voltage and current of this capacitor C₁, thereby realizing proportional-derivative (PD) feedback control of the voltage of the capacitor C₁ without employing a differentiating element for the differentiating portion of the PD loop coupled with the capacitor C₁. Avoiding the use of a differentiator reduces problems due to noise in the physical controller implementation.

Additionally, the BPCM buck converter 100 contains a proportional-integral-derivative (PID) controller, which is a control loop feedback mechanism that corrects an error between the output voltage and a desired voltage by calculating an error correction and then providing the error correction to adjust the output voltage. The PID controller contains proportional, integral, and derivative paths. The first of these paths determines the reaction to the current error, the second determines the reaction based on the sum of recent errors, and the third determines the reaction to the rate at which the error has been changing. A weighted sum of these paths is used to adjust the output voltage.

As shown, the buck converter 100 contains an output voltage controller 102 to which a negative reference voltage −V_{REF} is supplied through a low pass filter. The output voltage controller 102 is connected with an adder 104. The output of the adder 104 is connected with an input of a compensator 106. The compensator 106 may contain, for example, a proportional-integral (PI) feed forward in which the derivative path is eliminated, which, combined with the PD emulation of the BPCM feedback, leads to control solution functionally equivalent to that of a PID controller but with added immunity to circuit parasitics and switching noise. The output of the compensator 106 is connected with an input of a comparator 108 with hysteresis, which may be a conventional Schmitt trigger. The hysteresis of the comparator 108 provides a self-oscillation mechanism. The output of the comparator 108 alternates between the positive and negative supply voltages dependent on whether the voltage supplied to the positive terminal is larger than the voltage supplied to the negative voltage (which, as shown, is ground) or vice-versa.

The output of the comparator 108 is connected to a driver 110 to activate the driver 110, which in turn drives a pair of power transistors 112 connected in a simple push-pull configuration (although other configurations can be used). The transistors 112 can be field effect devices, such as MOSFETs, or bipolar devices, such as BJTs.

The outputs of the transistors 112 are connected to a first LC output filter 114. The first LC output filter 114 is connected in series with a second LC output filter 116. The first and second LC output filters form a 4^{th} order output filter, which decrease the ripple of the output voltage from the buck converter 100. The first and second LC output filters 114, 116 contain an inductor L₁, L₂ and a capacitor C₁, C₂, respectively. The switching frequencies of the transistors 112, which are much higher than the maximum frequency response of the human ear (about 20 kHz), cause radio-frequency interference. The output filters 114, 116 reduce this interference and allow the output signal to correspond to the input signal. However, as the output filters 114, 116 are potentially undamped and the current drawn from the output terminal (node Vₒᵤₜ) is time-varying, the output voltage Vₒᵤₜ is controlled via negative feedback. Multiple feedback loop are used because of the difficulty in compensating for the phase lag of the entire fourth order filter in a single control loop. The voltage from the second LC output filter 116 (the output voltage V_{OUT}) is integrated and supplied as feedback through an outer PD control loop to an operational amplifier (OpAmp) in the controller 102, where the difference between the reference signal V_{REF} and the output voltage V_{OUT} is used to adjust the voltage from the controller 102. The voltage from the first LC output filter 114 is supplied as feedback through an inner PD control loop to the adder 104 such that this voltage is subtracted from the voltage from the controller 102.

Rather than the currents in the output filters being directly supplied to an integrator to thereby provide PD feedback, these currents are estimated. Specifically, the current through the capacitor C₁ (and the current through the inductor L₁) in the first LC output filter 114 is estimated by sensing the voltage across the inductor L₁ in the first LC output filter 114 and then integrating or low-pass filtering the sensed result. The current through the capacitor C₂ (and the current through the inductor L₂) in the second LC output filter 116 is similarly estimated by sensing the voltage through the inductor L₂ in the second LC output filter 116. As the voltages through the inductors L₁, L₂ are relatively large, they may be sensed relatively easily. The estimate of the current through the capacitor C₁ in the first LC output filter 114 and the estimate of the current through the capacitor C₂ in the second LC output filter 116 are supplied to the adder 104 through first and second gains 118, 120, respectively. The first and second gains 118, 120 may be the same or different and are either preset (i.e., unchangeable once implemented) or controllable as desired. The amplified estimates are subtracted by the adder 104 so that the difference between the amplified estimates is added to the output of the controller 102 and the voltage of the capacitor C₁ of the first LC output filter 114 subtracted therefrom.

The resulting signals from the output filters 114, 116 emulate PD current feedback without the use of noise- and parasitic-sensitive differentiation of the capacitor voltages—in FIG. 1, only a single capacitor voltage is supplied directly as feedback to the output voltage controller 102. Instead, the inductor voltages in the LC output filters are sensed and the currents through the capacitors estimated and supplied as the PD feedback.

The manner in which the signals travel through the converter 100 is now described. Specifically, the OpAmp in the controller 102 receives a sine wave input. An integrator connected between the input and output of the controller 102 integrates the difference between input and output voltages of the OpAmp, resulting in the triangular waveform. The comparator 108 receives the triangular waveform, modified by the adder 104 and compensator 106 and generates square voltage pulses. These pulses are then amplified by the transistors 110 and transmitted to the output filters 112, 114 to reconstruct the desired output signal V_{OUT}. Note that switching of the comparator 108 at high speed results in a square wave whose pulse width and frequency is dependent on the input voltage and frequency and whose average value corresponds to the buck converter input.

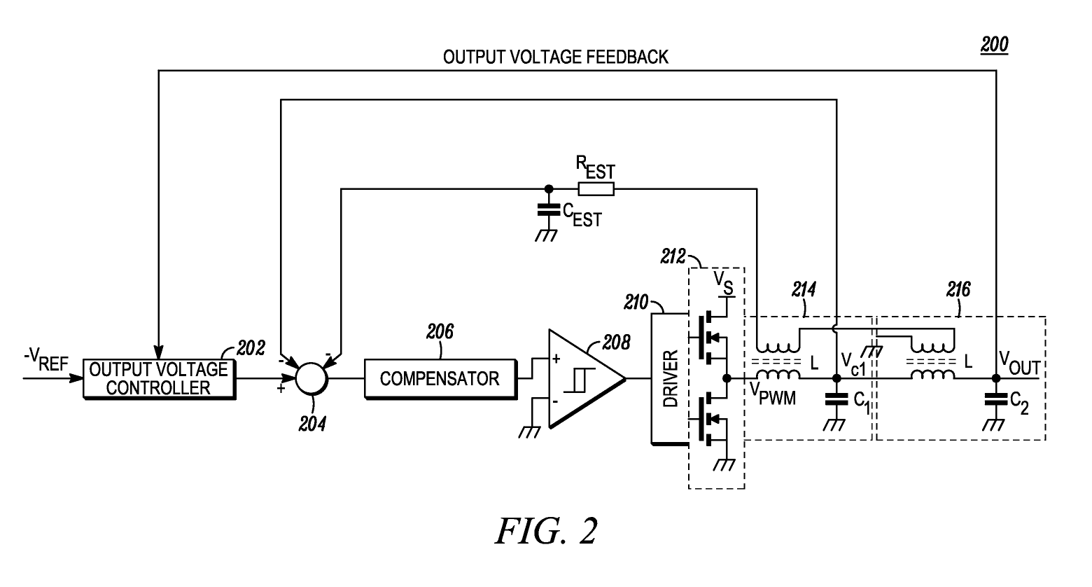

FIG. 2 illustrates another embodiment of a BPCM control buck converter. Similar to the embodiment of FIG. 1, the BPCM buck converter 200 of FIG. 2 contains an output voltage controller 202 to which a reference voltage is supplied, an adder 204, a compensator 206, a comparator 208 with hysteresis, a driver 210, transistors 212, and first and second LC output filters 214, 216. These elements are connected together in a manner similar to that of FIG. 1. Further, similar to the embodiment of FIG. 1, the voltages in the inductors L₁, L₂ in each of the first and second LC output filters 214, 216 are sensed and estimates are made of the current through the capacitor C₁, C₂. Specifically, in the embodiment of FIG. 2, the voltages in the inductors L₁, L₂ are sensed by extra windings. The current through the capacitor C₁ in the first LC output filter 214 is estimated using floating sense windings as a difference block. This voltage difference, which corresponds to the derivative of the capacitor C₁ current, is then integrated using a low pass filter Rₑₛₜ, Cₑₛₜ disposed in the feedback path between the first LC output filter 214 and the adder 204. Using this inner PD control loop permits a wide variety of outer PD control loops to be added.

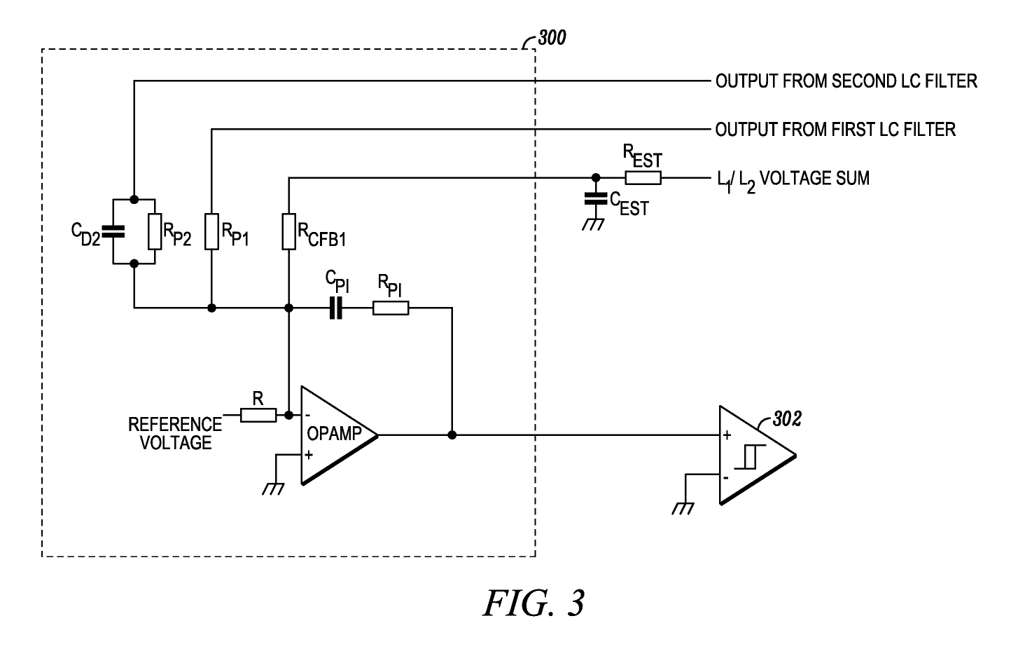

One example of an output voltage controller 300 is illustrated in FIG. 3. As shown, the output voltage from the capacitor C₂ of the second LC output filter 216 as shown in FIG. 2 is connected to the inverting terminal of the OpAmp in the controller 300 through a parallel resistor/capacitor R_{P2}, C_{D2} combination. The low-pass filtered voltage difference output between the inductors L₁, L₂ is connected to the inverting terminal of the OpAmp through a resistor R_{cfb1}. The capacitor C₁ is also connected to the inverting terminal of the OpAmp through a resistor R_{PI} to convert the current to a voltage. Feedback is supplied between the output and the inverting terminal of the OpAmp through another integrator of a series resistor/capacitor R_{PI}, C_{PI} combination.

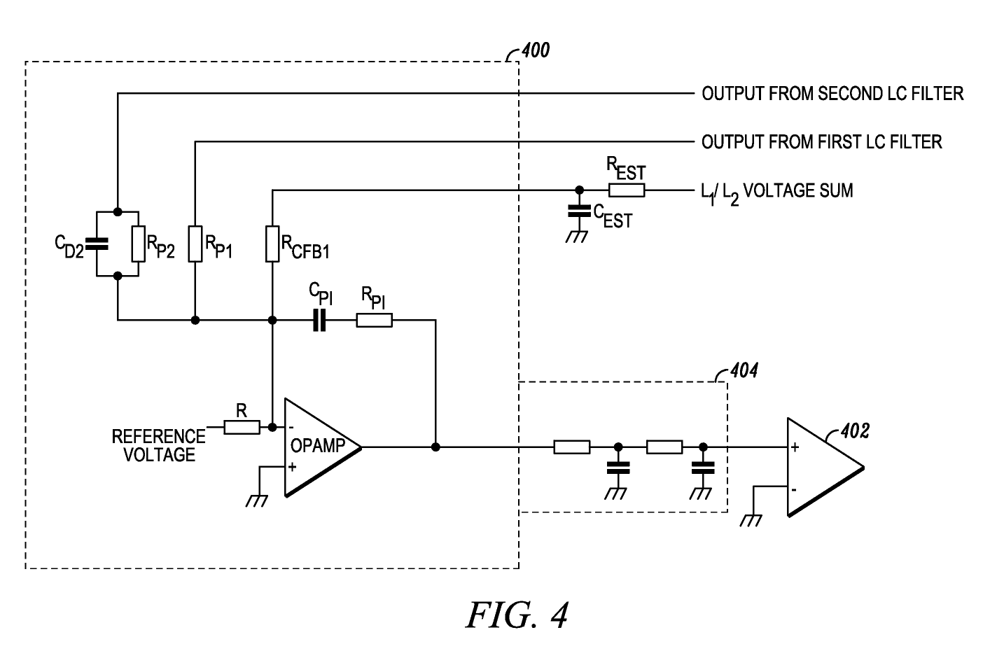

In another example of a controller and circuitry connected thereto is illustrated in FIG. 4, the voltage controller 400 is similar to that of FIG. 3. Unlike the embodiment of FIG. 3, in which a hysteresis-containing comparator is used to provide the self-oscillation, a phase-shift network provides the self oscillation by providing a phase shift to the output triangular wave from the OpAmp. Thus, rather than the output of the OpAmp of the voltage controller being connected directly to the input of a hysteresis-containing comparator, as shown in the embodiment of FIG. 4, the phase-shift network 404 is disposed between the output of the OpAmp of the voltage controller 400 and the input of a comparator 402. The comparator 402 of FIG. 4 does not contain hysteresis as the self oscillation is provided by the phase shift network. The phase-shift can either be preset or controllable as desired, with only the preset version being shown. Other implementations of a phase-shift network using different topologies may be used as desired.

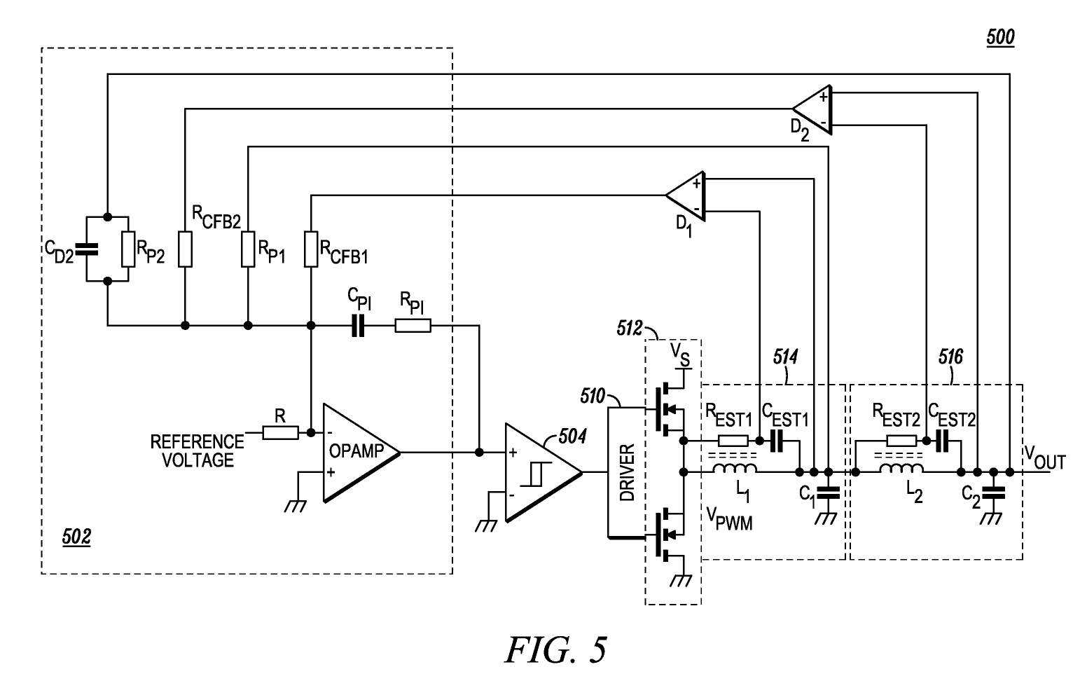

FIG. 5 illustrates another embodiment of a buck converter. This buck converter 500 contains a controller 502, a compensator 504 with hysteresis, a driver 510, a pair of push-pull transistors 512, and first and second LC output filters 514, 516 again connected in a manner similar to that of the buck converter 100 of FIGS. 1 and 2. Unlike the embodiment of FIG. 2, the buck converter 500 of FIG. 5 does not sense the voltage of the inductors using extra coils, which may be relatively large, bulky, and expensive. Instead, a series combination of an RC filter is connected in parallel with the inductor L₁, L₂ in each of the LC output filters 514, 516. The voltage across the capacitor Cₑₛₜ₁, Cₑₛₜ₂ in each of the series LC combinations provides the input to a differential amplifier D₁, D₂. The output of each differential amplifier D₁, D₂ is connected to the inverting terminal of the OpAmp through a respective resistor R_{cfb1}, R_{cfb2}.

Although only one type of filter is shown in the figures, filters with other characteristics and orders may be used. Each of these filters may contain an inductor of which the voltage thereacross is detected and the current estimated rather than being directly provided in a feedback loop. The components in the forward and reverse portion of the loop may be altered to achieve the desired loop characteristics.

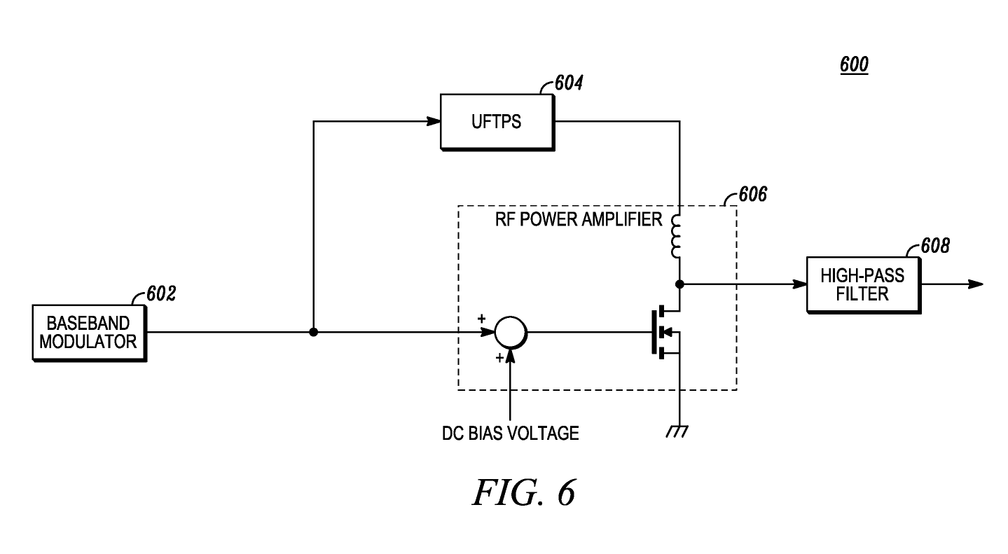

FIG. 6 illustrates a power amplifier system 600. The power amplifier system 600 contains a baseband modulator 602 whose output is connected to the inputs of both a UFTPS module 604 and a power amplifier module 606. The UFTPS module 604 contains a buck converter similar to that of FIGS. 1-5 and provides the power supply for the power amplifier module 606. As shown, the output voltage of the baseband modulator 602 is combined with a DC bias voltage and then amplified by a power transistor in the power amplifier module 606. The output of the UFTPS module 604 is provided as a supply voltage to the power transistor through an inductor. The output of the power amplifier module 606 is supplied to a high pass filter 608, whose output is provided as the output of the power amplifier system 600.

Note that although the embodiments shown in the figures contain multiple current estimators, in other embodiments at least one direct connection can be used and at least one current estimator can be used when multiple LC filters are used.

The buck converters and power amplifier described herein are useful in narrowband RF systems with variable RF amplitude. Such systems include Tetra (TErrestrial Trunked RAdio), Tetra2, iDen (Integrated Digital Enhanced Network) systems. The buck converters can be used in multiple communication applications including individual handsets and other subscriber applications or base stations.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

Those skilled in the art will recognize that a wide variety of modifications, alterations, and combinations can be made with respect to the above described embodiments without departing from the spirit and scope of the invention defined by the claims, and that such modifications, alterations, and combinations are to be viewed as being within the purview of the inventive concept. Thus, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

1. A switch-mode power converter comprising:
an output filter of at least fourth order containing a plurality of inductors and capacitors; and
a control system comprising a plurality of inductor estimators positioned to sense voltage across the inductors and estimate current through the inductors, a feedback loop providing the estimates to an input of the control system, and a self-oscillation mechanism to provide self-oscillation of the control system, wherein the output filter is connected with an output of the control system and comprises a plurality of low pass filters connected in series.

2. The switch-mode power converter of claim 1, wherein the control system comprises a forward feed path containing an OpAmp, a proportional-integral (PI) compensator, and a comparator, the PI compensator connected between the OpAmp and the comparator in the forward feed path.

3. The switch-mode power converter of claim 2, wherein the comparator contains hysteresis and is connected such that the self-oscillation mechanism comprises the comparator.

4. The switch-mode power converter of claim 2, wherein the control system further comprises a phase-shift network connected between the OpAmp and comparator, the self-oscillation mechanism comprising the phase-shift network and the comparator.

5. The switch-mode power converter of claim 2, further comprising second feedback loops each connecting one of the capacitors with an inverting input of the OpAmp, one of the second feedback loops containing a resistor and another of the second feedback loops containing a parallel combination of a capacitor and another resistor.

6. The switch-mode power converter of claim 2, wherein the feedback loop comprises a gain disposed between each inductor estimator and the input of the control system, each gain being independently controllable.

7. The switch-mode power converter of claim 2, wherein each inductor estimator comprises extra windings coupled to the respective inductor.

8. The switch-mode power converter of claim 7, wherein the feedback loop comprises a low pass filter and the extra windings are connected in series between ground and the low pass filter.

9. The switch-mode power converter of claim 2, wherein each inductor estimator comprises a series combination of a resistor and a capacitor connected in parallel with the respective inductor.

10. The switch-mode power converter of claim 9, wherein each inductor estimator further comprises a differential amplifier whose inputs are connected to either side of the respective capacitor.

11. The switch-mode power converter of claim 2, wherein the control system further comprises a driver driving power transistors connected in a push-pull configuration, the driver and power transistors connected between the OpAmp and the output filter.

12. A method of providing power conversion comprising:
providing a feed forward path;
providing self-oscillation along the feed forward path;
low pass filtering a self-oscillated signal using an output filter of at least fourth order;
estimating current through inductors in the output filter by sensing voltages of the inductors; and
feeding back the estimates along a feedback loop to the feed forward path.

13. The method of claim 12, further comprising providing a differential amplification and proportional-integral (PI) compensation along the forward feed path.

14. The method of claim 12, wherein providing the self-oscillation comprises providing a comparator containing hysteresis.

15. The method of claim 12, wherein providing the self-oscillation comprises providing a controllable phase-shift network connected between a differential amplifier and a comparator in the feed forward path.

16. The method of claim 12, further comprising providing independently controllable gain for each inductor current along the feedback loop.

17. The method of claim 12, wherein each estimation is provided using extra windings coupled to the respective inductor.

18. The method of claim 12, wherein each estimation is provided using a series combination of a resistor and a capacitor connected in parallel with the respective inductor.
